(19) United States
(12) Patent Application Publication
(10) Pub. No.: US 2010/0153610 A1
(43) Pub. Date: Jun. 17, 2010

(54) BUS ARBITER AND BUS SYSTEM

(75) Inventor: Yutaka Kawashima, Kanagawa-ken (JP)

Correspondence Address: SPRINKLE IP LAW GROUP, 1301 W. 25TH STREET, SUITE 408, AUSTIN, TX, 78705, US

(73) Assignee: Kabushiki Kaisha Toshiba, Tokyo (JP)

(21) Appl. No.: 12/637,183

(22) Filed: Dec. 14, 2009

(30) Foreign Application Priority Data
Dec. 15, 2008 (JP) 2008-318887

(51) Int. Cl. G06F 13/28; G06F 13/36

(52) U.S. Cl. 710/308

(57) ABSTRACT

A bus interface unit receives first and second data sent out to a data bus and observes address values indicated on an address bus. The first and second data are written into first and second registers respectively. First and second address detection unit receive the address values observed by the bus interface respectively. The first address detection unit outputs a first detection signal when it detects an address value which corresponds with the value of the first data. The second address detection unit outputs a second detection signal, when it detects an address value having an increment from the first data, which corresponds with the value of the second data. A control unit raises the priority of one of the bus masters given a bus utilization right, during the period from a start of outputting the first detection signal to an end of outputting the second detection signal.

### CROSS REFERENCE TO RELATED APPLICATION

This application is based upon and claims the benefit of priority from the prior Japanese Patent Application No. 2008-318887, filed on Dec. 15, 2008, the entire contents of which are incorporated herein by reference.

### FIELD OF THE INVENTION

The invention relates to a bus arbiter to arbitrate bus utilization right among bus masters, and to a bus system provided with the bus arbiter.

### DESCRIPTION OF THE BACKGROUND

A bus arbiter is provided in a bus system in which bus masters are connected to a bus. When bus requests transmitted from the bus masters overlap with each other, the bus arbiter arbitrates bus utilization right. As a system of arbitrating priority of bus utilization right, a fixed priority scheduling system or a round robin scheduling system are known, for example.

A bus master having a bus utilization right of a higher priority may issue a bus request in order to acquire the bus utilization right, when a bus master having a bus utilization right of a lower priority acquires the bus utilization right and is performing a data transfer on the bus. In the above case, the bus arbiter switches the bus utilization right to the former bus master having the higher priority in accordance with an arbitration method used.

In such a case, the latter bus master having the lower priority loses the bus utilization right during data transfer, and must temporarily stop the data transfer at the time point. The latter bus master needs to acquire the bus utilization right again to resume the data transfer.

However, even the bus master with the lower priority may need to transfer data continuously without losing of the bus utilization right, in some cases. A requirement of such a data transfer data is made in a DMA transfer of a descriptor format, for example. According to the DMA transfer, a fixed amount of data is collectively transferred on the basis of information described on a descriptor table. The information relates to an amount of data to be transferred. In the DMA transfer, successive data such as image data, which requires high throughput, needs to be transferred.

Japanese Patent Application Publication No. 07-248997 (Page 3, and FIG. 1) discloses a bus control system suitable for such a requirement. In the bus control system, a bus master unit, which is connected to a bus, is configured to output a request signal for bus utilization priority, in addition to an ordinary bus utilization request signal. In the bus control system, when the request signal for bus utilization priority is outputted from a bus master unit which is handling data having an attribute to be sent out immediately, a bus arbiter preferentially grants the bus utilization right to the bus master unit.

In the bus control system, even the bus master unit ordinary having a bus utilization right of a lower priority can continuously transfer data, which requires high throughput, by outputting the request signal for bus utilization priority. Therefore, the processing performance of the bus system can be improved.

In the bus control system, it is necessary to provide each bus master unit with a circuit to output a request signal for bus utilization priority.

On the other hand, as the circuit scale of LSIs increases, general-purpose LSIs with actual achievement are generally used in bus master units to shorten the development cycle. However, when such a general-purpose LSI is used, it is practically difficult to design and use a bus master unit specialized for the bus control system mentioned above, newly.

Since bus systems are different from each other in setting priority of bus utilization right, for example, each LSI for use in a bus arbiter is designed in accordance with the specification of the bus system containing the bus arbiter. Thus, the bus arbiter is desired to manage the change of priority of bus utilization right as mentioned above.

### SUMMARY OF THE INVENTION

An aspect of the invention provides a bus arbiter connected to a data bus and an address bus to arbitrate bus utilization right among bus masters, which includes a bus interface unit to connect with the data bus and the address bus, the bus interface unit receiving data sent out to the data bus and observing address values indicated on the address bus, a first register where first data is written, the first data being sent out to the data bus and being received by the bus interface, a second register where second data is written, the second data being sent out to the data bus and being received by the bus interface, a first address detection unit to receive the address values observed by the bus interface, the first address detection unit outputting a first detection signal when the first address detection unit detects an address value which corresponds with the value of the first data written in the first register, a second address detection unit to receive the address values observed by the bus interface, the second address detection unit outputting a second detection signal when the second address detection unit detects an address value having an increment from the first data written in the first register address, the increment corresponding with the value of the second data written in the second register, and a bus utilization right control unit to raise the priority of one of the bus masters given a bus utilization right, during the period from a start of outputting the first detection signal to an end of outputting the second detection signal.

Another aspect of the invention provides a bus system, which includes a data bus and an address bus, and bus masters, a bus arbiter, a memory and a central processing unit, respectively connected with the data bus and the address bus, the bus arbiter or the central processing unit utilizes the data bus and the address bus when the bus arbiter or the central processing unit sends out a bus utilization request signal to the bus arbiter and receives a bus utilization grant signal, the arbiter containing a bus interface unit to connect with the data bus and the address bus, the bus interface unit receiving data sent out to the data bus and observing address values indicated on the address bus, a first register where first data is written, the first data being sent out to the data bus and being received by the bus interface, a second register where second data is written, the second data being sent out to the data bus and being received by the bus interface, a first address detection unit to receive the address values observed by the bus interface, the first address detection unit outputting a first detection signal when the first address detection unit detects an address value which corresponds with the value of the first data written in the first register, a second address detection unit to receive the address values observed by the bus interface, the second address detection unit outputting a second detection signal when the second address detection unit detects an address value having an increment from the first data written in the first register address, the increment corresponding with the value of the second data written in the second register, and a bus utilization right control unit to raise the priority of one of the bus masters given a bus utilization right, during the period from a start of outputting the first detection signal to an end of outputting the second detection signal.

### BRIEF DESCRIPTION OF THE DRAWINGS

FIG. 1 is a block diagram showing a configuration of a bus arbiter according to a first embodiment of the invention;

FIG. 2 is a block diagram showing an example of an internal configuration of a transfer end address detection unit of the bus arbiter according to the first embodiment;

FIG. 3 is a block diagram showing an example of a schematic configuration of a bus system using the bus arbiter according to the first embodiment;

FIG. 4 is a wave form chart showing an operational example of the bus system shown in FIG. 3;

FIG. 5 is a block diagram showing a configuration of a bus arbiter according to a second embodiment of the invention;

FIG. 6 is a wave form chart showing an operational example of the bus arbiter according to the second embodiment;

FIG. 7 is a block diagram showing a configuration of a bus arbiter according to a third embodiment of the invention; and

FIGS. 8A and 8B are respectively wave form charts showing operational examples of enabling registers used in the bus arbiter of the third embodiment.

### DETAILED DESCRIPTION OF THE INVENTION

Hereinafter, bus arbiters of embodiments of the invention will be described with reference to the drawings. In the drawings, the same reference numerals designate the same portions or similar portions respectively.

The bus arbiters arbitrate bus utilization right. The bus arbiters are suitable for a DMA transfer of a descriptor format. In the DMA transfer, successive data is transferred on the basis of information regarding a base address and a data size described in a descriptor table.

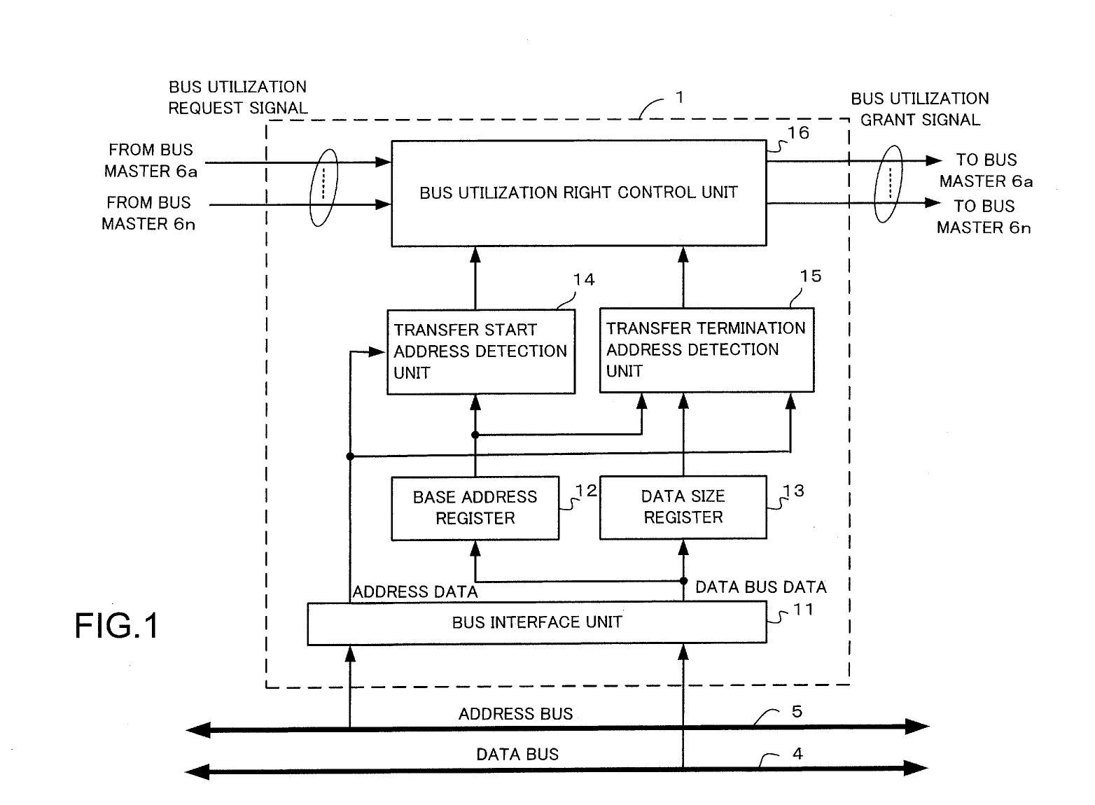

FIG. 1 is a block diagram showing a bus arbiter according to a first embodiment of the invention.

As shown in FIG. 1, the bus arbiter 1 of the embodiment includes a bus interface unit 11, a base address register 12 as a first address register, a data size register 13 as a second address register, a transfer start address detection unit 14, a transfer end address detection unit 15, and a bus utilization right control unit 16.

The bus interface unit 11 is connected to a data bus 4 and an address bus 5. The bus interface unit 11 has a function to receive data sent out to the data bus 4, and to observe values of address data on the address bus 5.

A value of the base address, as first data, is described in a descriptor table held in a memory (not shown). The described value of the base address is sent out to the data bus 4 by a CPU (not shown) and is received by the bus interface unit 11. The received value of the base address is written into the base address register 12. A value of a data size, as second data, is described in the descriptor table held in the memory. The described value of the data size is sent out to the data bus 4 by the CPU and is received by the bus interface unit 11. The received value of the data size is written into the data size register 13.

The transfer start address detection unit 14 receives the value of the address data observed by the bus interface unit 11. The transfer start address detection unit 14 outputs a transfer start detection signal to the bus utilization right control unit 16, when the unit 14 detects that the value of the received address corresponds with the value of the base address written in the base address register 12.

The transfer end address detection unit 15 receives the value of the address data observed by the bus interface unit 11. The transfer end address detection unit 15 outputs a transfer end detection signal to the bus utilization right control unit 16, when the unit 15 detects that an increment of the received address from the value of the base address written in the base address register 12 corresponds with the value of the data size written in the data size register 13.

When the bus utilization right control unit 16 receives bus utilization request signals from the bus masters 6a to 6n, the bus utilization right control unit 16 determines the priority order, and supplies a bus utilization enabling signal to the bus masters 6a to 6n sequentially.

The bus utilization right control unit 16 is capable of changing the priority order of the bus utilization right from the priority order determined in advance. When the priority order is changed, the priority of the bus master, which acquires the bus utilization right, is raised higher than an ordinary priority, during the period from a start of outputting the transfer start detection signal to an end of outputting the transfer end detection signal.

The bus interface unit 11 receives data including a base address and a data size sent out to the data bus 4 in accordance with access from a master which is a CPU. The bus interface unit 11 writes the received data into the base address register 12 and the data size register 13, the addresses of which are designated by the address bus 5.

By control of the master, the value of the base address and the value of the data size, which are sent out to the data bus 4 and are described in the descriptor table, are respectively written into the base address register 12 and the data size register 13 through the bus interface unit 11.

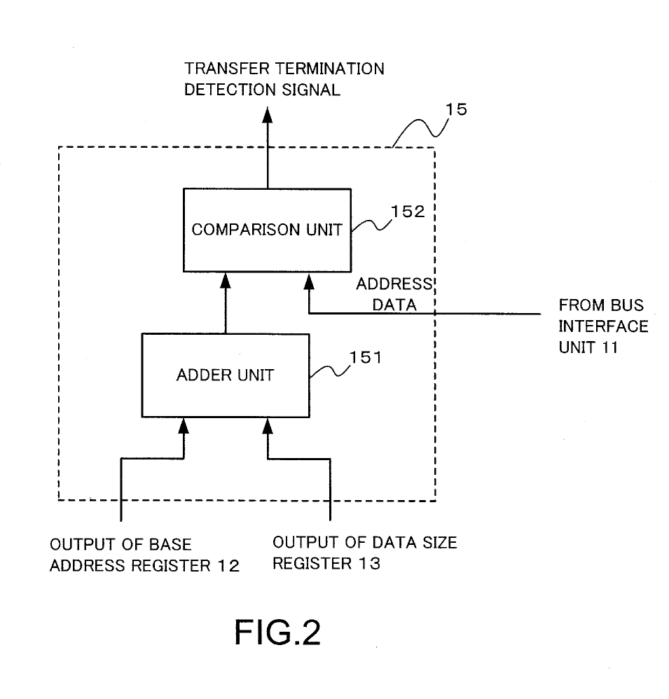

FIG. 2 shows an example of an internal configuration of the transfer end address detection unit 15.

As shown in FIG. 2, the transfer end address detection unit 15 includes an adder unit 151 and a comparison unit 152.

The adder unit 151 adds the value of the base address outputted from the base address register 12 and the value of the data size outputted from the data size register 13. The comparison unit 152 compares a value outputted from the adder unit 151 with the value of the address data sent out from the bus interface unit 11. The comparison unit 152 outputs the transfer end detection signal when those values match with each other.

The adder unit 151 calculates the address value of the transfer end address in advance by adding the address value of the base address and the value of the data size.

In the case of transferring successive data, the value of the address data is incremented one after another. Accordingly, the comparison unit 152 outputs the transfer end detection signal, when the value of the address data on the address bus 5 reaches the calculated address value of the transfer end address.

Returning to FIG. 1, the bus utilization right control unit 16 usually arbitrates the bus utilization right among the plurality of bus masters 6a to 6n on the basis of the priority order determined in advance. When a plurality of the bus masters among the bus masters 6a to 6n input a bus utilization request signal into the bus utilization right control unit 16 and overlap with each other, the bus utilization enabling signal is sequentially outputted to each bus master in accordance with the priority order determined in advance.

However, when the transfer start address detection unit 14 outputs the transfer start detection signal, the bus utilization right control unit 16 changes the priority order of the bus utilization right of the bus masters 6a to 6n so that the priority of the bus master which is acquired the bus utilization right at that time, may be raised higher than the ordinary priority. The changed priority order is held from the start of outputting a transfer start detection signal to the end of outputting a transfer end detection signal from the transfer end address detection unit 15.

By such a control of the bus utilization right control unit 16, even the bus master having the bus utilization right of a lower priority order can continue the data transfer being executed until the transfer is completed.

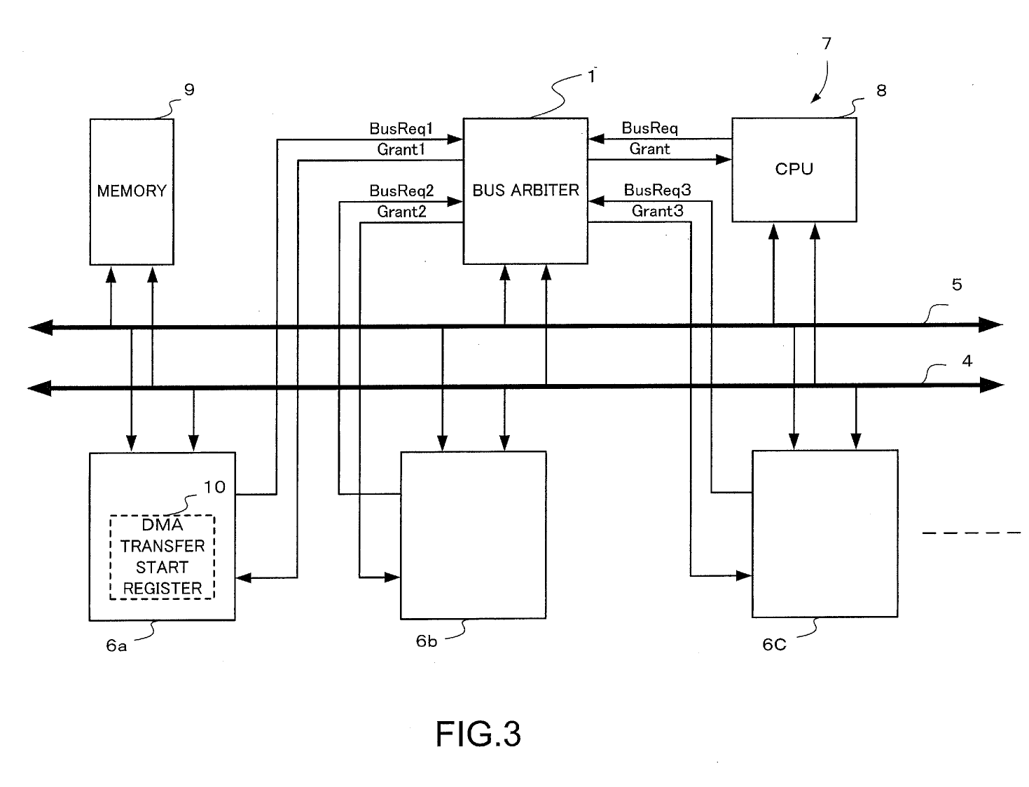

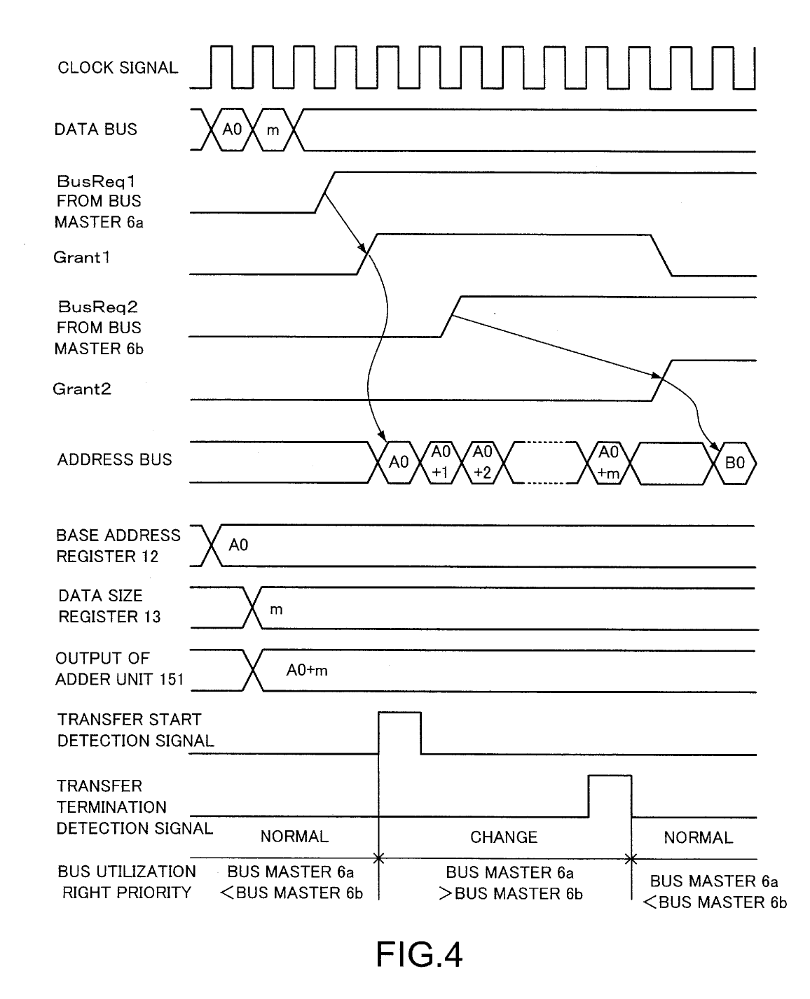

A specific example of the aforementioned change operation of the priority order of the bus utilization right by the bus utilization right control unit 16 will be described using FIGS. 3 and 4.

FIG. 3 shows an example of a schematic configuration of a bus system using the bus arbiter of the embodiment.

In the bus system 7 shown in FIG. 3, a central processing unit (hereinafter, referred to as a “CPU”) 8, a memory 9, the bus masters 6a, 6b, 6c, . . . , and the bus arbiter 1 are connected to an address bus 5 and a data bus 4.

The CPU 8 and the bus masters 6a, 6b, 6c, . . . output bus utilization request signals Busreq and Busreq1, Busreq2, Busreq3, . . . respectively to acquire a bus utilization right in order to transfer data from and to the memory 9.

When the outputs of these bus utilization request signals overlap with each other, the bus arbiter 1 arbitrates the bus utilization right, and outputs the bus utilization enabling signal to one of the bus masters. In FIG. 3, bus utilization enabling signals to be transmitted to the CPU 8 and the bus masters 6a, 6b, 6c, . . . are expressed as Grant and Grant1, Grant2, Grant3, . . . respectively.

In the embodiment, an ordinary priority of the bus utilization right is set so that the priority of the bus master 6a is low, the priority of the bus master 6b is middle, and the priority of the bus master 6c is high. The priority order is as follows.

Bus Master 6a<Bus Master 6b<Bus Master 6c

Hereinafter, the embodiment will be described for the case where the bus master 6a exchanges data between the memory 9 and the bus master 6a by a DMA transfer of a descriptor format, for example.

In the DMA transfer of the descriptor format, the CPU 8 creates a descriptor table in the memory 9 prior to the transfer. The descriptor table describes the value of a base address and the value of a data size in a data area to be transferred which is stored in the memory 9.

Then, the CPU 8 sets a start bit (raises a flag) in a DMA transfer start register 10 of the bus master 6a so that the DMA transfer is instructed. The bus master 6a accesses the memory 9, and acquires the descriptor table. Subsequently, on the basis of the value of the base address and the value of the data size described in the descriptor table, the bus master 6a accesses the memory 9 again, and transfers the data to be transferred.

Such a DMA transfer of the descriptor format is suitable for successive transfer of data collectively stored in a region of the memory 9.

In the bus system 7, while the bus master 6a acquires the bus utilization right and is performing the DMA transfer of the descriptor format, the bus arbiter 1 raises the priority of the bus utilization right of the bus master 6a and keeps the data transfer, which is performed by the bus master 6a, from being interrupted.

When the transfer start address detection unit 14 shown in FIG. 1 starts outputting the transfer start detection signal, the bus arbiter 1 changes the priority of the bus utilization right so that the priority of the bus master 6a is middle, the priority of the bus master 6b is low, and the priority of the bus master 6c is high. The priority order of the bus utilization right is changed as follows.

Bus Master 6b<Bus Master 6a<Bus Master 6c

When the DMA transfer of the descriptor format is completed by the bus master 6a, the transfer end address detection unit 15 shown in FIG. 1 outputs a transfer end detection signal. The bus utilization right control unit 16 receives the output of the transfer end detection signal so that the bus arbiter 1 returns the priority order of the bus utilization right to the ordinary priority order.

FIG. 4 is a wave form chart showing an example of the change operation of the priority order of the bus utilization right in the bus system 7. The example shows the operation, when the bus utilization request signal BusReq2 is outputted from the bus master 6b having of a priority of bus utilization right higher than that of the bus master 6a while the bus master 6a is performing the DMA transfer of the descriptor format. A clock signal shown in FIG. 4 shows a synchronizing clock signal which is used when data is transmitted to the data bus 4 and the address bus 5 or when data is and of received from the data bus 4 and the address bus 5.

The CPU 8 sends the bus utilization request signal BusReq to the bus arbiter 1, and receives the bus utilization enabling signal Grant. The CPU 8 accesses the memory 9 and writes a descriptor table and transfer data into the memory 9 so that the bus master 6a may perform a DMA transfer of a descriptor format (Step 1). The descriptor table describes the value A0 of a base address and the value m of the data size of a region where the transfer data is stored. The value “m” is a positive integer.

Then, the CPU 8 designates the base address register 12 of the bus arbiter 1 as an access destination, and sends out the value A0 of the base address on the descriptor table written in the memory 9 to the data bus 4. The bus interface unit 11 of the bus arbiter 1 writes the sent out value A0 of the base address into the base address register 12 (Step 2).

Subsequently, the CPU 8 designates the data size register 13 of the bus arbiter 1 as an access destination, and sends out the value m of the data size on the descriptor table written in the memory 9 to the data bus 4. The bus interface unit 11 writes the sent out value m of the data size into the data size register 13 (Step 3).

As a result, the adder unit 151 of the transfer end address detection unit 15 of the bus arbiter 1 outputs an addition output (A0+m) (Step 4).

Then, the CPU 8 sets a start bit (raises a flag) in the DMA start register 10 of the bus master 6a, and instructs the bus master 6a to perform the DMA transfer. In response to the instruction, the bus master 6a sends out the bus utilization request signal BusReq1 to the bus arbiter 1 (Step 5).

When the bus master 6a receives the bus utilization enabling signal Grant1 from the bus arbiter 1, which receives the bus utilization request signal BusReq1, the bus master 6a starts the DMA transfer of the descriptor format (Step 6).

At this time, the bus master 6a accesses the memory 9, and acquires the value A0 of the base address and the value m of the data size described in the descriptor table. On the basis of the acquired values A0 and m, the bus master 6a reads the data from the address A0 to the address (A0+m) in the memory 9 successively, and sends out the data to the address bus 5. The address values A0 to (A0+m) are also successively sent out to the address bus 5 (Step 7).

The bus interface unit 11 of the bus arbiter 1 sends out the value of the address, which has been sent out to the address bus 5, to the transfer start address detection unit 14 and the transfer end address detection unit 15 of the bus arbiter 1 (Step 8).

The transfer start address detection unit 14 outputs the transfer start detection signal, when the address value corresponding with the value A0 of the base address written in the base address register 12 is sent out to the address bus 5 (Step 9).

When the transfer start detection signal is outputted, the bus utilization right control unit 16 of the bus arbiter 1 changes the priority of the bus utilization right. The priority of the bus master 6a is changed from low to middle, and the priority of the bus master 6b is changed from middle to low (Step 10).

Therefore, even when the bus master 6b outputs the bus utilization request signal BusReq2 during the DMA transfer by the bus master 6a, the bus master 6a has the priority order of the bus utilization right higher than that of the bus master 6b, and thus the bus master 6a successively keeps performing the DMA transfer (Step 11).

The change of the priority of the bus utilization right is continued until the address value (A0+m), which is the transfer end address, is sent out to the address bus 5 so that the transfer end detection signal is outputted from the transfer end address detection unit 15 (Step 12).

When the transfer end detection signal is outputted from the transfer end address detection unit 15 completely, the bus utilization right control unit 16 of the bus arbiter 1 returns the priority of the bus utilization right to the ordinary setting. Moreover, the bus arbiter 1 outputs the bus utilization enabling signal Grant2 to the bus master 6b. The output allows the bus master 6b to start a data transfer. An address of initial data, for example, B0 is sent out to the address bus 5 (Step 13).

According to the embodiment mentioned above, the bus arbiter 1 is capable of performing such a change to raise the priority of the bus utilization right in the case of transferring successive data. Therefore, it is not always necessary to provide a bus master with a special circuit for request of bus utilization priority.

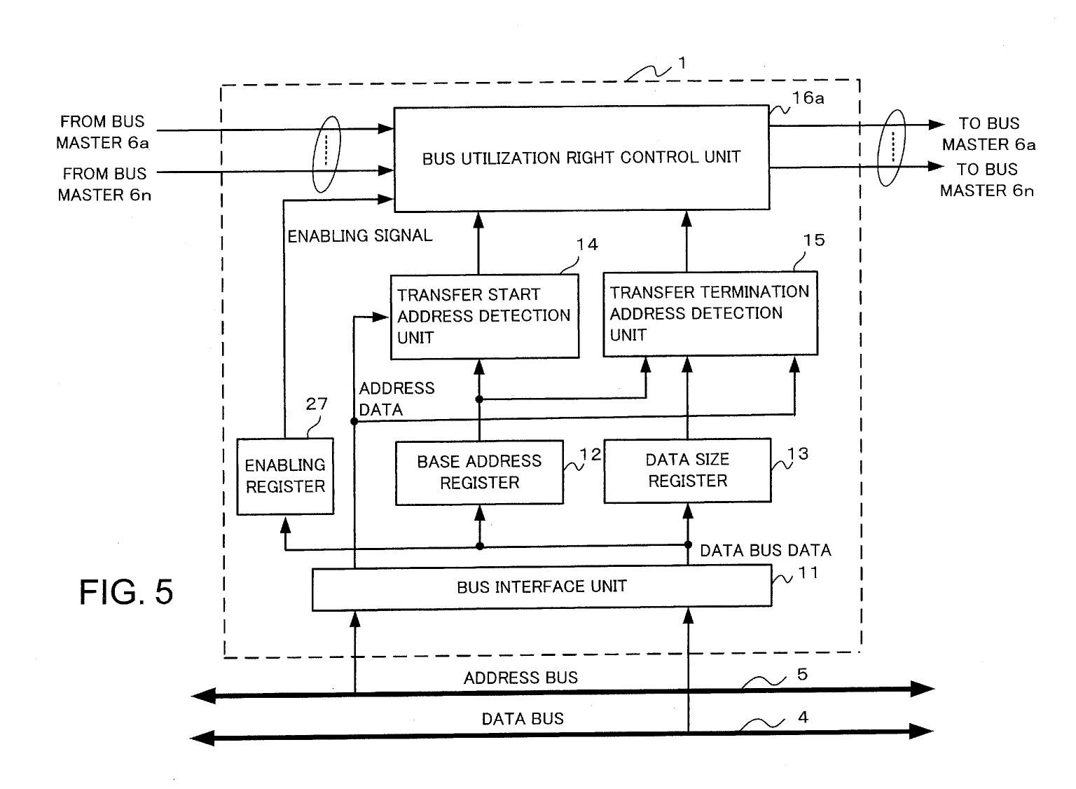

FIG. 5 is a block diagram showing a configuration of a bus arbiter according to a second embodiment.

In the embodiment, the bus arbiter additionally has a function to set whether change operation of the priority of the bus utilization right is actually executed or not.

As shown in FIG. 5, a bus arbiter 2 of the embodiment is configured by adding an enabling register 27, as a third address register, to the bus arbiter 1 of the first embodiment. By an enabling signal outputted from the enabling register 27, a bus utilization right control unit 16a is controlled whether change operation of the priority of the bus utilization right is executed or not.

The enabling register 27 is a register into which enabling signal data sent out to the data bus 4 is written through the bus interface unit 11. A value of the data written in the enabling register 27 is held until the next writing is performed.

By the enabling signal outputted from the enabling register 27, the bus utilization right control unit 16a is controlled as to whether change operation of the priority of the bus utilization right is to actually executed or not. For example, the change operation is executed when the enabling signal is ‘1’, while the change operation is not executed when the enabling signal is ‘0’.

The other operations to change the priority of the bus utilization right in the bus arbiter 2 are the same as those in the bus arbiter 2 of the first embodiment.

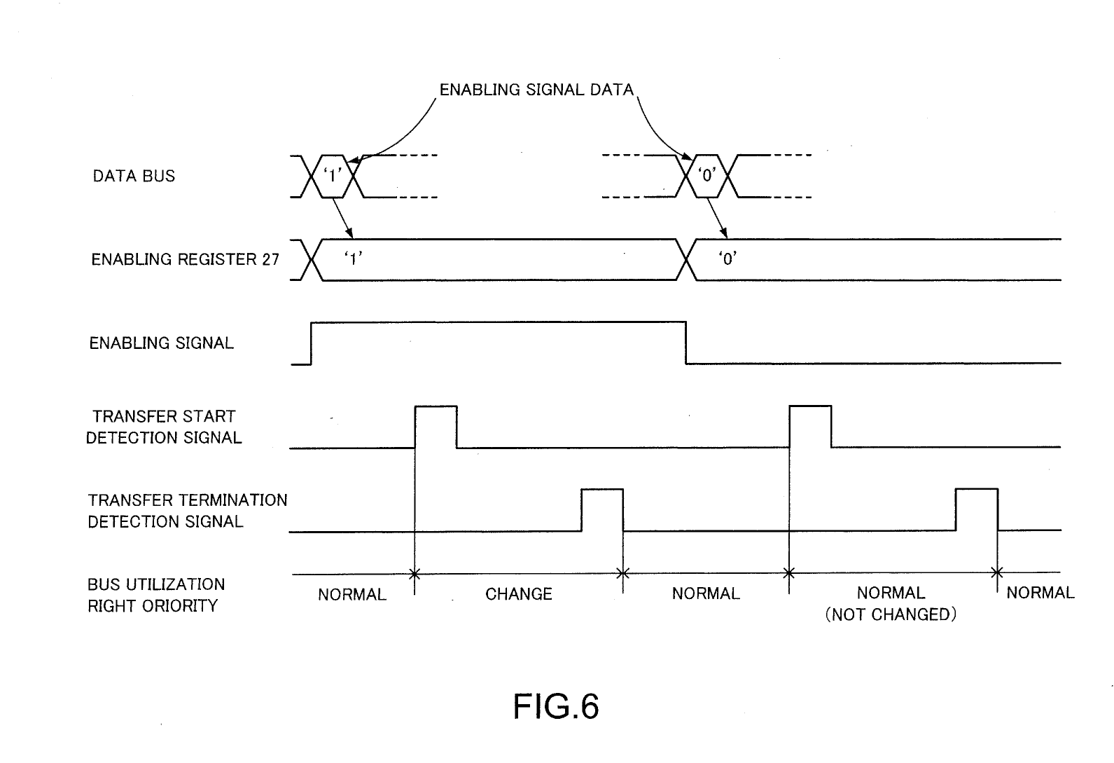

FIG. 6 shows a relationship between the writing of the enabling signal data into the enabling register 27 and the change operation of the priority of the bus utilization right by the bus utilization right control unit 16a.

When ‘1’ is sent out as the enabling signal data to the data bus 4, and ‘1’ is written into the enabling register 27, the enabling signal outputted from the enabling register 27 to the bus utilization right control unit 16a becomes ‘1’.

When the enabling signal is ‘1’, the bus utilization right control unit 16a raises the priority of the bus utilization right of one of the bus masters 6a to 6n which is using the data bus 4, during the period from a start of outputting a transfer start detection signal to an end of outputting a transfer end detection signal as similar to the case of the first embodiment.

On the other hand, when ‘0’ is sent out as the enabling signal data to the data bus 4, and ‘0’ is written into the enabling register 27, the enabling signal becomes ‘0’. In such a case, the bus utilization right control unit 16a does not execute change operation of the priority of the bus utilization right.

Therefore, the bus utilization right among the bus masters 6a to 6n is arbitrated in accordance with an ordinary priority order during the period from the start of outputting of the transfer start detection signal to the end of outputting of the transfer end detection signal.

According to the embodiment, the enabling function is implemented to change the priority of the bus utilization right, by providing the enabling register 27 in the bus arbiter 2. The change of the priority of the bus utilization right can be more finely controlled by the enabling function. For example, even when a bus master having the high priority performs a data transfer, it is possible to perform a control in a way not to change the priority of the bus utilization right, depending on bus utilization circumstances of the other bus masters connected to the same data bus.

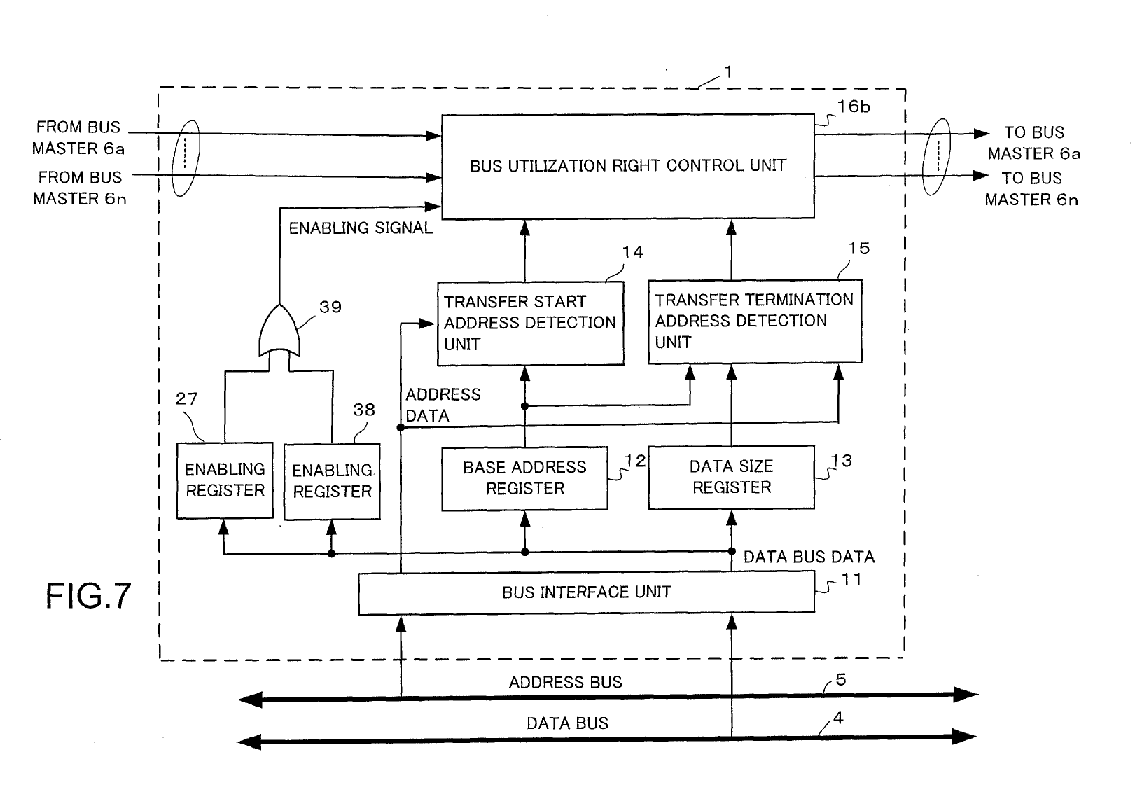

FIG. 7 is a block diagram showing a configuration of a bus arbiter according to a third embodiment of the invention.

The bus arbiter of the embodiment is configured by adding an enabling register 38, as a fourth address register, and an OR gate 39, to the bus arbiter 2 of the second embodiment.

Enabling signal data sent out to the data bus 4 is written into the enabling register 38 through the bus interface unit 11, as similar to the case of the enabling register 27 of the second embodiment.

Unlike in the case of the enabling register 27 of the second embodiment, the data written in the enabling register 38 is cancelled by a transfer end detection signal outputted from the transfer end address detection unit 15. For canceling the data, even if ‘1’ is written into the enabling register 38, as an enabling signal, the output of the enabling register 38 becomes ‘0’ when a single series of successive data transfer is completed.

The output of the enabling register 27 and the output of the enabling register 38 are inputted into the OR gate 39. The output of the OR gate 39 is inputted into the bus utilization right control unit 16a, as an enabling signal.

‘1’ is not written into both of the enabling registers 27, 38 simultaneously. Either of the enabling registers 27, 38 is selected, and ‘1’ is written into the selected enabling register.

The two enabling registers 27, 38 may be used on a case-by-case basis.

The enabling register 27 may be used when a data transfer, which has bus utilization right under a raised priority, is successively performed multiple times. In such a case, the enabling signal data ‘1’ may be written into the enabling register 27 only at the initial time. The enabling signal data ‘0’ may be written into the enabling register 27 only at the final time.

On the other hand, the enabling register 38 is used when a data transfer, which has bus utilization right under a raised priority, is performed as one shot. In such a case, when the data transfer is completed, the data of the enabling register 38 is automatically cancelled. Therefore, it is unnecessary to write the enabling signal data ‘0’ again.

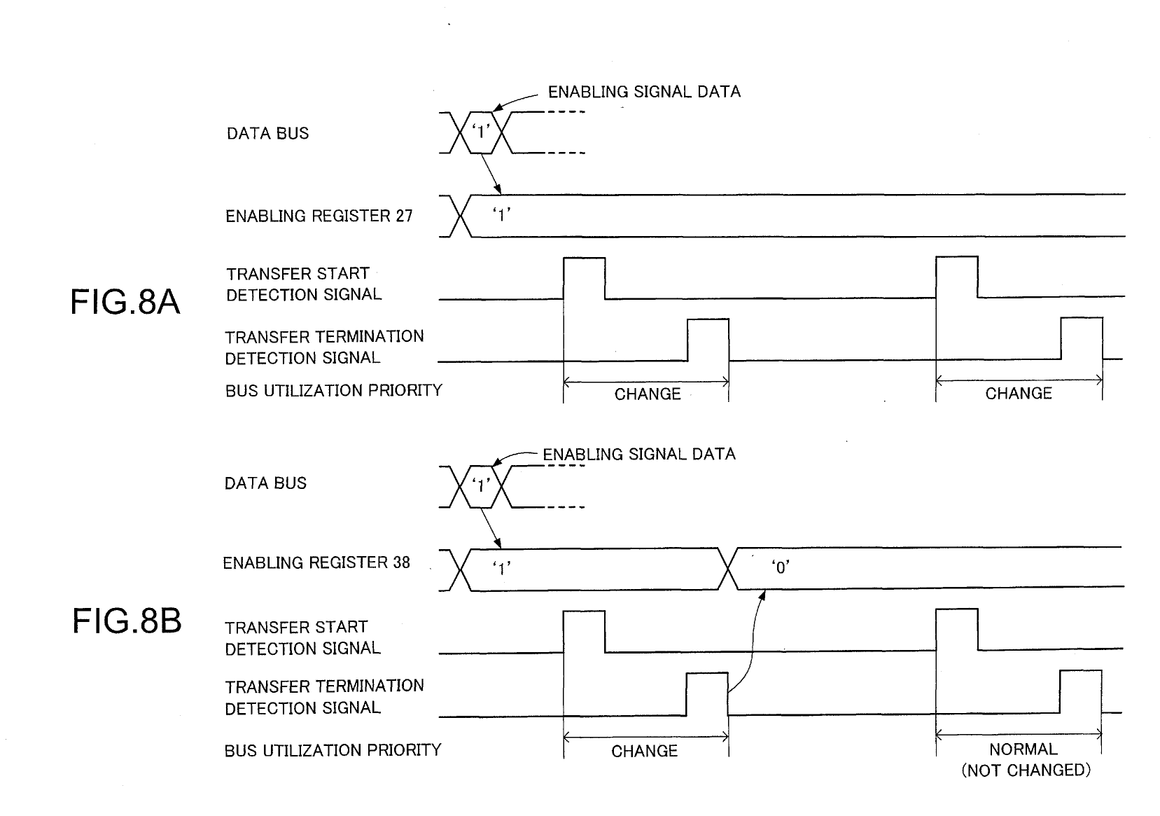

FIGS. 8A and 8B are respectively wave form charts showing operational examples of the enabling registers 27, 38 used in the bus arbiter of the third embodiment.

As shown in FIG. 8A, once ‘1’ is written as the enabling signal data, the enabling register 27 holds the data ‘1’ until ‘0’ is written next time.

Therefore, when the successive data is transferred multiple times, and a transfer start detection signal and a transfer end detection signal are outputted multiple times during the period, the bus arbiter 3 changes the priority of the bus utilization right every time the transfer start detection signal is outputted.

On the other hand, as shown in FIG. 8B, when ‘1’ is written as an enabling signal data, and a transfer end detection signal is subsequently outputted, the data in the enabling register 38 is cancelled, and the output of the enabling register 38 is changed to ‘0’.

Accordingly, the bus arbiter 3 changes the priority of the bus utilization right only at the time of a single data transfer after the enabling signal data ‘1’ is written. As for the subsequent data transfer, the bus arbiter 3 arbitrates the bus utilization right in accordance with an ordinary priority.

According to the embodiment, the two enabling registers 27, 38 are provided to write enabling signal data. The number of time, when the enabling signal data is written into the enabling registers 27, 38, can be reduced by using these two enabling registers 27 38, based on the pattern of a data transfer.

The bus masters used in the embodiments are suitable for a DMA transfer of a descriptor format. The bus utilization right control of the embodiments can also be applied to bus masters which perform processing other than the DMA transfer.

Other embodiments or modifications of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. A bus arbiter connected to a data bus and an address bus to arbitrate bus utilization right among bus masters, comprising:
a bus interface unit to connect with the data bus and the address bus, the bus interface unit receiving data sent out to the data bus and observing address values indicated on the address bus;
a first register where first data is written, the first data being sent out to the data bus and being received by the bus interface;
a second register where second data is written, the second data being sent out to the data bus and being received by the bus interface;
a first address detection unit to receive the address values observed by the bus interface, the first address detection unit outputting a first detection signal when the first address detection unit detects an address value which corresponds with the value of the first data written in the first register;
a second address detection unit to receive the address values observed by the bus interface, the second address detection unit outputting a second detection signal when the second address detection unit detects an address value having an increment from the first data written in the first register address, the increment corresponding with the value of the second data written in the second register; and
a bus utilization right control unit to raise the priority of one of the bus masters given a bus utilization right, during the period from a start of outputting the first detection signal to an end of outputting the second detection signal.

2. A bus arbiter according to claim 1, wherein a ordinary priority order is set for bus utilization with the bus masters, in the bus utilization right control unit, preliminarily.

3. A bus arbiter according to claim 1, wherein raising the priority of the one of the bus masters by the bus utilization right control unit is a change to raise the priority higher than the ordinary priority order.

4. A bus arbiter according to claim 3, wherein raising the priority of the one of the bus masters by the bus utilization right control unit is a change to raise the priority higher than that of at least one of the other bus masters.

5. A bus arbiter according to claim 1, wherein the first data is a base address, the second data is a data size, and wherein the bus utilization right control unit sends out a bus utilization enabling signal to the one of the bus masters so as to allow data transfer between the one of the bus masters and a memory.

6. A bus arbiter according to claim 5, wherein the data transfer is a DMA transfer.

7. A bus arbiter according to claim 5, wherein the second address detection unit includes:
an adder unit to add the first data written in the first register and the second data written in the second register; and
a comparison unit to output the second detection signal when an observed address value corresponds with the output value from the adder unit.

8. A bus arbiter according to claim 1, further comprising a third register where enabling signal data is written, the enabling signal data being sent out to the data bus and being received by the bus interface, wherein whether the bus utilization right control unit executes to change the priority of the bus utilization right or not is controlled by the value of an enabling signal obtained from the third register.

9. A bus arbiter according to claim 8, further comprising:
a fourth register where enabling signal data is written and is cancelled by the second detection signal; and
an OR gate to receive the enabling signal from the third or the fourth register and to provide the enabling signal to the bus utilization right control unit, wherein
whether the bus utilization right control unit executes to change the priority of the bus utilization right or not is controlled by the value of the enabling signal.

10. A bus arbiter according to claim 9, wherein writing the enabling signal in the third or the fourth register is performed selectively.

11. A bus system, comprising a data bus and an address bus, and bus masters, a bus arbiter, a memory and a central processing unit, respectively connected with the data bus and the address bus, the bus arbiter or the central processing unit utilizes the data bus and the address bus when the bus arbiter or the central processing unit sends out a bus utilization request signal to the bus arbiter and receives a bus utilization grant signal, the arbiter including:
a bus interface unit to connect with the data bus and the address bus, the bus interface unit receiving data sent out to the data bus and observing address values indicated on the address bus;
a first register where first data is written, the first data being sent out to the data bus and being received by the bus interface;
a second register where second data is written, the second data being sent out to the data bus and being received by the bus interface;
a first address detection unit to receive the address values observed by the bus interface, the first address detection unit outputting a first detection signal when the first address detection unit detects an address value which corresponds with the value of the first data written in the first register;
a second address detection unit to receive the address values observed by the bus interface, the second address detection unit outputting a second detection signal when the second address detection unit detects an address value having an increment from the first data written in the first register address, the increment corresponding with the value of the second data written in the second register; and
a bus utilization right control unit to raise the priority of one of the bus masters given a bus utilization right, during the period from a start of outputting the first detection signal to an end of outputting the second detection signal.

12. A bus system according to claim 11, wherein a ordinary priority order is set for bus utilization with the bus masters, in the bus utilization right control unit, preliminarily.

13. A bus system according to claim 11, wherein raising the priority of the one of the bus masters by the bus utilization right control unit is a change to raise the priority higher than the ordinary priority order.

14. A bus system according to claim 11, wherein the first data is a base address, the second data is a data size, and wherein the bus utilization right control unit sends out a bus utilization enabling signal to the one of the bus masters so as to allow data transfer between the one of the bus masters and a memory.

15. A bus system according to claim 14, wherein the second address detection unit includes:
an adder unit to add the first data written in the first register and the second data written in the second register; and
a comparison unit to output the second detection signal when an observed address value corresponds with the output value from the adder unit.

16. A bus system according to claim 14, further comprising a third register where enabling signal data is written, the enabling signal data being sent out to the data bus and being received by the bus interface, wherein whether the bus utilization right control unit executes to change the priority of the bus utilization right or not is controlled by the value of an enabling signal obtained from the third register.

17. A bus system according to claim 16, further comprising:
a fourth register where enabling signal data is written and is cancelled by the second detection signal; and
an OR gate to receive the enabling signal from the third or the fourth register and to provide the enabling signal to the bus utilization right control unit,
wherein the enabling signal data is written into the third or the fourth register selectively, and whether the bus utilization right control unit executes to change the priority of the bus utilization right or not is controlled by the value of the enabling signal.

18. A bus system according to claim 17, wherein the third register is selected, and plural times of data transfer is performed with a raised priority of bus utilization right successively.

19. A bus system according to claim 17, wherein the fourth register is selected, and a single time of data transfer is performed with a raised priority of bus utilization right.
